(19) United States
(12) Patent Application Publication
(10) Pub. No.: US 2025/0153539 A1
(43) Pub. Date: May 15, 2025

(54) VEHICLE THERMAL MANAGEMENT SYSTEM

(71) Applicants: HYUNDAI MOTOR COMPANY, Seoul (KR); KIA CORPORATION, Seoul (KR)

(72) Inventors: Seong Bin Jeong, Seongnam-si (KR); Yong Woong Cha, Yongin-si (KR); Dong Seok Oh, Hwaseong-si (KR); Chang Gi Ryu, Seoul (KR); Yeon Ho Kim, Seoul (KR); Dae Hyun Song, Seoul (KR); Jong Hwan Kwon, Seoul (KR); Jae Yeon Kim, Hwaseong-si (KR); Jung Ha Park, Gunpo-si (KR)

(73) Assignees: HYUNDAI MOTOR COMPANY, Seoul (KR); KIA CORPORATION, Seoul (KR)

(21) Appl. No.: 18/667,216

(22) Filed: May 17, 2024

(30) Foreign Application Priority Data
Nov. 9, 2023 (KR) 10-2023-0154837

(51) Int. Cl. B60H 1/00; B60H 1/32

(52) U.S. Cl. CPC B60H 1/00885; B60H 1/00278; B60H 1/32284; B60H 2001/00307

(57) ABSTRACT

A vehicle thermal management system includes: a refrigerant system having a compressor, a water-cooled condenser, a chiller-side expansion valve, and a chiller; and a coolant system having a cabin heater, a battery, a power electronics (PE) component, and a control valve unit. The water-cooled condenser includes a refrigerant passage through which a refrigerant passes, and a coolant passage through which a coolant passes. The control valve unit is configured to allow the coolant passage of the water-cooled condenser and the cabin heater to be fluidly connected or disconnected.

### CROSS-REFERENCE TO RELATED APPLICATION

This application claims the benefit of and priority to Korean Patent Application No. 10-2023-0154837, filed on Nov. 9, 2023, the disclosure of which is incorporated herein in its entirety by reference.

### TECHNICAL FIELD

The present disclosure relates to a vehicle thermal management system. More particularly, the present disclosure relates to a vehicle thermal management system designed to efficiently perform heating and cooling of a cabin, thermal management of a battery, and thermal management of a power electronics (PE) component.

### BACKGROUND

With a growing interest in energy efficiency and environmental issues, it is desired to develop eco-friendly vehicles that can replace internal combustion engine vehicles. Such eco-friendly vehicles are classified into electric vehicles which are driven using fuel cells or electricity as a power source and hybrid vehicles which are driven using an engine and a battery.

Electric vehicles or hybrid vehicles may include a vehicle thermal management system for heating, ventilation, and air conditioning (HVAC) in a cabin (or passenger compartment) and maintaining a battery and a power electronics (PE) component at optimal temperatures. The vehicle thermal management system may include a refrigerant system for HVAC in the cabin, and a coolant system for maintaining the battery and the PE component at appropriate temperatures.

The refrigerant system may be designed to perform the heating and cooling of the cabin using phase changes of a refrigerant circulating through a compressor, a condenser, an expansion valve, and an evaporator. The refrigerant system may be thermally connected to the coolant system through various heat exchangers and/or chillers.

The refrigerant system according to the related art may include an interior condenser disposed in an HVAC case, and the interior condenser may be configured to condense the refrigerant and heat air flowing into the cabin. However, the air heating efficiency by the condensation of the refrigerant may not be very high, resulting in relatively reduced cabin heating performance.

In the vehicle thermal management system according to the related art, the refrigerant system and the coolant system may have very complex configurations, resulting in high manufacturing cost. Additionally, heat transfer efficiency between the refrigerant and the coolant may not be high, resulting in performance deterioration in cabin HVAC, thermal management of the battery, and thermal management of the PE component.

The above information described in this background section is provided to assist in understanding the background of the inventive concept. Additionally, the background section may include any technical concept that does not form the prior art that is already known to those having ordinary skill in the art.

### SUMMARY

The present disclosure has been made to solve the above-mentioned problems occurring in the prior art while advantages achieved by the prior art are maintained intact.

An aspect of the present disclosure provides a vehicle thermal management system designed to efficiently perform the heating and cooling of a cabin, thermal management of a battery, and thermal management of a power electronics (PE) component.

According to another aspect of the present disclosure, a vehicle thermal management system may include a refrigerant system including a compressor, a water-cooled condenser, a chiller-side expansion valve, and a chiller. Additionally, the vehicle thermal management system may include a coolant system including a cabin heater, a battery, a PE component, and a control valve unit. The water-cooled condenser may include a refrigerant passage through which a refrigerant passes, and a coolant passage through which a coolant passes. The control valve unit may be configured to allow the coolant passage of the water-cooled condenser and the cabin heater to be fluidly connected to or disconnected from each other.

The control valve unit may be configured to allow the coolant passage of the water-cooled condenser and the battery to be fluidly connected to or disconnected from each other.

The control valve unit may include a first cabin port and a second cabin port configured to fluidly communicate with the cabin heater.

The control valve unit may include a first condenser port and a second condenser port configured to fluidly communicate with the coolant passage of the water-cooled condenser.

The control valve unit may be configured to allow the first cabin port and the first condenser port to be fluidly connected to or disconnected from each other. The control valve unit may be configured to allow the second cabin port and the second condenser port to be fluidly connected to or disconnected from each other.

The coolant system may include a cabin pump configured to fluidly connect to the first cabin port.

The control valve unit may include a battery port configured to fluidly communicate with the battery, and a component port configured to fluidly communicate with the PE component.

The coolant system may include a battery pump configured to fluidly connect to the battery port.

The coolant system may further include a radiator configured to fluidly connect to the control valve unit. The control valve unit may include a radiator port configured to fluidly communicate with the radiator.

The coolant system may include a radiator pump configured to fluidly connect to the radiator port.

The control valve unit may be configured to allow the coolant passage of the water-cooled condenser and the radiator to be fluidly connected to or disconnected from each other.

The control valve unit may be configured to allow the radiator to be fluidly connected to the PE component and/or the battery.

The chiller may include a refrigerant passage through which the refrigerant passes, and a coolant passage through which the coolant passes.

The control valve unit may include a first chiller port and a second chiller port configured to fluidly communicate with the coolant passage of the chiller.

The control valve unit may be configured to allow the battery port to be fluidly connected to at least one of the first chiller port, the radiator port, or the first condenser port.

The control valve unit may be configured to allow the component port to be fluidly connected to at least one of the radiator port or the first chiller port.

The control valve unit may be configured to allow the radiator port to be fluidly connected to at least one of the component port, the first condenser port, or the battery port.

The coolant system may further include an auxiliary pump configured to fluidly connect to the control valve unit. The control valve unit may further include an auxiliary port configured to fluidly communicate with the auxiliary pump.

The control valve unit may be configured to allow the auxiliary port and the second chiller port to be fluidly connected to or disconnected from each other.

### BRIEF DESCRIPTION OF THE DRAWINGS

The above and other objects, features, and advantages of the present disclosure should be more apparent from the following detailed description taken in conjunction with the accompanying drawings:

FIG. 1 illustrates a vehicle thermal management system according to an embodiment of the present disclosure;

FIG. 2 illustrates a state in which a vehicle thermal management system according to an embodiment of the present disclosure operates in a first mode;

FIG. 3 illustrates a state in which a vehicle thermal management system according to an embodiment of the present disclosure operates in a second mode;

FIG. 4 illustrates a state in which a vehicle thermal management system according to an embodiment of the present disclosure operates in a third mode;

FIG. 5 illustrates a state in which a vehicle thermal management system according to an embodiment of the present disclosure operates in a fourth mode;

FIG. 6 illustrates a state in which a vehicle thermal management system according to an embodiment of the present disclosure operates in a fifth mode;

FIG. 7 illustrates a vehicle thermal management system according to another embodiment of the present disclosure; and

FIG. 8 illustrates a vehicle thermal management system according to another embodiment of the present disclosure.

### DETAILED DESCRIPTION

Hereinafter, embodiments of the present disclosure are described in detail with reference to the accompanying drawings. In the drawings, the same reference numerals are used throughout to designate the same or equivalent elements. In addition, a detailed description of well-known techniques associated with the present disclosure has been ruled out in order not to unnecessarily obscure the gist of the present disclosure.

Terms such as first, second, A, B, (a), and (b) may be used to describe the elements in the embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those having ordinary skill in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

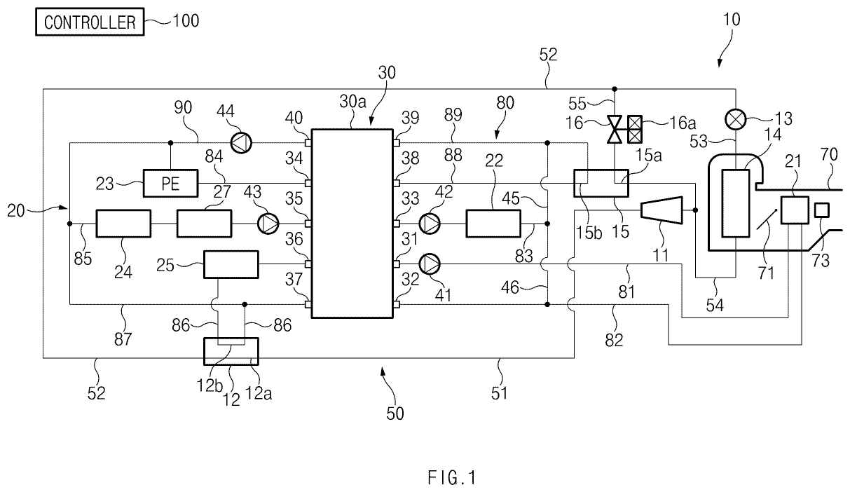

Referring to FIG. 1, a vehicle thermal management system according to an embodiment of the present disclosure may include a refrigerant system 10 thermally connected to a cabin (or passenger compartment). The vehicle thermal management system may also include a coolant system 20 thermally connected to a cabin heater 21, a battery 22, and a power electronics (PE) component 23.

The refrigerant system 10 may include a compressor 11, a water-cooled condenser 12, a cooling-side expansion valve 13, an evaporator 14, a chiller 15, and a chiller-side expansion valve 16.

The compressor 11 may compress a refrigerant to allow the refrigerant to circulate. According to an embodiment, the compressor 11 may be an electric compressor driven by electric energy.

The water-cooled condenser 12 may be thermally connected to the coolant system 20, and the water-cooled condenser 12 may be configured to transfer heat between the refrigerant circulating in the refrigerant system 10 and a coolant circulating in the coolant system 20. The water-cooled condenser 12 may include a refrigerant passage 12a through which the refrigerant passes, and a coolant passage 12b through which the coolant passes. The refrigerant passing through the refrigerant passage 12a may transfer heat to the coolant passing through the coolant passage 12b so that the refrigerant may be cooled and condensed, and the coolant may be heated.

The cooling-side expansion valve 13 may be located between the refrigerant passage 12a of the water-cooled condenser 12 and the evaporator 14. When the refrigerant system 10 operates in a cooling mode, the cooling-side expansion valve 13 may be configured to expand the refrigerant received from the refrigerant passage 12a of the water-cooled condenser 12. In addition, the cooling-side expansion valve 13 may be configured to adjust the flow rate of the refrigerant into the evaporator 14.

According to an embodiment, the cooling-side expansion valve 13 may be a thermal expansion valve (TXV) that senses the temperature and/or pressure of the refrigerant and adjusts the opening degree of the cooling-side expansion valve 13. Specifically, the cooling-side expansion valve 13 may be a TXV having a solenoid valve (not shown) selectively blocking or unblocking the flow of the refrigerant into an internal passage of the cooling-side expansion valve 13. The solenoid valve may be opened or closed by a controller 100, thereby unblocking or blocking the flow of the refrigerant into the cooling-side expansion valve 13. When the solenoid valve is opened, the refrigerant may be allowed to flow into the cooling-side expansion valve 13, and when the solenoid valve is closed, the refrigerant may be blocked from flowing into the cooling-side expansion valve 13. According to an embodiment, the solenoid valve may be mounted in a valve body of the cooling-side expansion valve 13 so that it may be configured to open or close the internal passage of the cooling-side expansion valve 13. According to another embodiment, the solenoid valve may be disposed upstream of the cooling-side expansion valve 13 so that it may be configured to selectively open or close an inlet of the cooling-side expansion valve 13. When the solenoid valve is closed, the refrigerant may not be directed to the cooling-side expansion valve 13 and the evaporator 14. Accordingly, the cooling operation of the refrigerant system 10 may not be performed. When the solenoid valve is opened, the refrigerant may be directed to the cooling-side expansion valve 13 and the evaporator 14. In other words, when the solenoid valve of the cooling-side expansion valve 13 is opened, the refrigerant system 10 may operate in the cooling mode.

The evaporator 14 may be configured to evaporate the refrigerant expanded by the cooling-side expansion valve 13 to thereby cool the air flowing into the cabin.

The refrigerant system 10 may include a refrigerant circulation path 50 allowing the refrigerant to circulate. The refrigerant circulation path 50 may include a first refrigerant line 51 extending from an outlet of the compressor 11 to an inlet of the refrigerant passage 12a of the water-cooled condenser 12. The refrigerant circulation path 50 may also include a second refrigerant line 52 extending from an outlet of the refrigerant passage 12a of the water-cooled condenser 12 to the inlet of the cooling-side expansion valve 13. Additionally, the refrigerant circulation path 50 may include: a third refrigerant line 53 extending from an outlet of the cooling-side expansion valve 13 to an inlet of the evaporator 14; and a fourth refrigerant line 54 extending from an outlet of the evaporator 14 to an inlet of the compressor 11.

In addition, the refrigerant circulation path 50 may include a distribution line 55 extending from the second refrigerant line 52 to the fourth refrigerant line 54. The distribution line 55 may be configured to guide the flow of the refrigerant from an upstream point of the cooling-side expansion valve 13 to an upstream point of the compressor 11. Specifically, an inlet of the distribution line 55 may be connected to the second refrigerant line 52 on the upstream side of the cooling-side expansion valve 13, and an outlet of the distribution line 55 may be connected to the fourth refrigerant line 54 on the upstream side of the compressor 11.

The refrigerant system 10 may include the chiller 15 located between the refrigerant passage 12a of the water-cooled condenser 12 and the compressor 11. The chiller 15 may be disposed in the distribution line 55. The chiller 15 may be configured to transfer heat between the refrigerant circulating in the refrigerant system 10 and the coolant circulating in the coolant system 20 on the upstream side of the compressor 11. The chiller 15 may include a refrigerant passage 15a through which the refrigerant passes, and a coolant passage 15b through which the coolant passes. The refrigerant passage 15a of the chiller 15 may be fluidly connected to the distribution line 55 of the refrigerant circulation path 50.

The refrigerant system 10 may include the chiller-side expansion valve 16 located on the upstream side of the refrigerant passage 15a of the chiller 15 in the distribution line 55. The chiller-side expansion valve 16 may be configured to adjust the flow of the refrigerant and/or the flow rate of the refrigerant into the refrigerant passage 15a of the chiller 15. Additionally, the chiller-side expansion valve 16 may be configured to expand the refrigerant received from the refrigerant passage 12a of the water-cooled condenser 12. According to an embodiment, the chiller-side expansion valve 16 may be an electronic expansion valve (EXV) having an actuator 16a. The actuator 16a may have a shaft that is movable to open or close an orifice defined in a valve body of the chiller-side expansion valve 16. The position of the shaft may be varied depending on the rotation direction, rotation degree, and the like of the actuator 16a. Accordingly the opening degree of the orifice of the chiller-side expansion valve 16 may be varied. The controller 100 may control the operation of the actuator 16a. In addition, the chiller-side expansion valve 16 may be a full open type EXV. As the opening degree of the chiller-side expansion valve 16 is varied, the flow rate of the refrigerant into the refrigerant passage 15a of the chiller 15 may be varied. In a state in which the chiller-side expansion valve 16 is fully opened (i.e., the opening degree of the chiller-side expansion valve 16 is 100%), the refrigerant may not be expanded while passing through the chiller-side expansion valve 16.

The vehicle thermal management system 10 according to an embodiment of the present disclosure may include an HVAC case 70 mounted on a dash panel of the vehicle. The evaporator 14 and the cabin heater 21 may be disposed inside the HVAC case 70. The cabin heater 21 may be disposed on the downstream side of the evaporator 14 in an air flow direction. An air mixing door 71 may be disposed between the evaporator 14 and the cabin heater 21. An electric heater 73 may be disposed inside the HVAC case 70, and the electric heater 73 may be configured to heat the air flowing into the cabin using electric energy. The electric heater 73 may be disposed on the downstream side of the cabin heater 21 in the air flow direction.

According to the embodiments illustrated in FIGS. 1 to 6, a cooling module adjacent to a front grille (not illustrated) of the vehicle may only include a radiator 24, and a motor of a cooling fan may be changed to a relatively inexpensive DC motor. As a result, the manufacturing cost may be reduced.

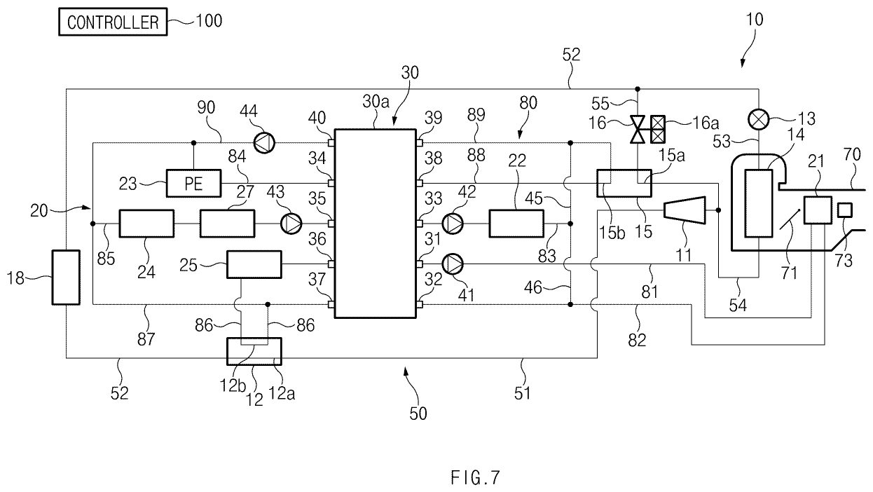

Referring to FIG. 7, the vehicle thermal management system according to an embodiment of the present disclosure may further include an air-cooled condenser 18 disposed on the downstream side of the refrigerant passage 12a of the water-cooled condenser 12. The air-cooled condenser 18 may have a refrigerant passage provided therein, and the refrigerant may pass through the refrigerant passage of the air-cooled condenser 18. The air-cooled condenser 18 may be disposed adjacent to the front grille of the vehicle, and the air-cooled condenser 18 may directly contact ambient air so that heat may be transferred between the refrigerant and the ambient air in the air-cooled condenser 18. In particular, the air-cooled condenser 18 may exchange heat with the ambient air forcibly blown by the cooling fan so that a heat transfer rate between the refrigerant and the ambient air may be further increased.

The coolant system 20 may include the cabin heater 21, the battery 22, the PE component 23, and a control valve unit 30.

The cabin heater 21 may have a coolant passage provided therein. The coolant passing through the coolant passage of the cabin heater 21 may transfer heat to the air passing by an exterior surface of the cabin heater 21 so that the air passing by the exterior surface of the cabin heater 21 may be heated, and the coolant passing through the coolant passage of the cabin heater 21 may be cooled.

The battery 22 may have a coolant passage provided inside or outside thereof. As the coolant passes through the coolant passage of the battery 22, the coolant may be heated or cooled so that the battery 22 may be maintained at an appropriate temperature. For example, the battery 22 may be a high-voltage battery pack of an electric vehicle.

The PE component 23 may have a coolant passage provided inside or outside thereof. As the coolant passes through the coolant passage of the PE component 23, the coolant may be heated or cooled so that the PE component 23 may be maintained at an appropriate temperature. For example, the PE component 23 may be an electric motor, an inverter, an autonomous driving controller, and the like, which are driving sources of an electric vehicle.

According to an embodiment of the present disclosure, the control valve unit 30 may be configured to allow the coolant passage 12b of the water-cooled condenser 12 and the cabin heater 21 to be fluidly connected or disconnected. When the coolant passage 12b of the water-cooled condenser 12 and the cabin heater 21 are fluidly connected by the control valve unit 30, the coolant heated by the water-cooled condenser 12 may pass through the coolant passage of the cabin heater 21, and the cabin heater 21 may effectively heat the air flowing into the cabin so that the cabin heating performance may be improved. Thus, the coolant heated by the water-cooled condenser 12 may heat the air flowing into the cabin through the cabin heater 21 disposed in the HVAC case 70 so that the heating of the cabin may be efficiently performed. In the vehicle thermal management system according to the related art, since an interior condenser that condenses the refrigerant is provided in an HVAC case, air heating performance of the interior condenser may be relatively reduced. In addition, the interior condenser may be relatively expensive. On the other hand, the vehicle thermal management system according to an embodiment of the present disclosure may achieve relatively high air heating performance using the cabin heater 21, and the cabin heater 21 may be relatively inexpensive.

According to an embodiment of the present disclosure, the control valve unit 30 may be configured to allow the coolant passage 12b of the water-cooled condenser 12 and the battery 22 to be fluidly connected or disconnected. When the coolant passage 12b of the water-cooled condenser 12 and the battery 22 are fluidly connected by the control valve unit 30, the coolant heated by the water-cooled condenser 12 may pass through the coolant passage of the battery 22 so that it may properly warm up the battery 22.

The coolant system 20 may further include the radiator 24 fluidly connected to the control valve unit 30. The radiator 24 may be disposed adjacent to the front grille of the vehicle, and the radiator 24 may have a coolant passage provided therein. The coolant passing through the coolant passage of the radiator 24 may be cooled by the ambient air passing by an exterior surface of the radiator 24. The radiator 24 may cool the coolant using the ambient air forcibly blown by a cooling fan (not shown).

According to an embodiment of the present disclosure, the control valve unit 30 may be configured to allow the coolant passage 12b of the water-cooled condenser 12 and the radiator 24 to be fluidly connected or disconnected. When the coolant passage 12b of the water-cooled condenser 12 and the radiator 24 are fluidly connected by the control valve unit 30, the coolant cooled by the radiator 24 may pass through the coolant passage 12b of the water-cooled condenser 12 so that the refrigerant may be effectively condensed by the water-cooled condenser 12.

According to an embodiment of the present disclosure, the control valve unit 30 may be configured to allow the radiator 24 to be fluidly connected to the PE component 23 and/or the battery 22. When the radiator 24 is fluidly connected to the PE component 23 and/or the battery 22 by the control valve unit 30, the coolant cooled by the radiator 24 may pass through the coolant passage of the PE component 23 and/or the coolant passage of the battery 22 so that the PE component 23 and/or the battery 22 may be properly cooled.

According to an embodiment of the present disclosure, the control valve unit 30 may be configured to allow the battery 22 and the PE component 23 to be fluidly connected or disconnected. When the battery 22 and the PE component 23 are fluidly connected by the control valve unit 30, the coolant discharged from the PE component 23 may pass through the radiator 24 and the battery 22.

The coolant system 20 may further include a reservoir tank 27 fluidly connected to the control valve unit 30. The reservoir tank 27 may be fluidly connected to the radiator 24. The reservoir tank 27 may temporarily store the coolant. When a coolant pressure in the radiator increased to a predetermined pressure or higher, the reservoir tank 27 may receive the coolant, or when the coolant pressure in the radiator 24 is lower than the predetermined pressure, the reservoir tank 27 may replenish the coolant. According to an embodiment of the present disclosure, the reservoir tank 27 may be connected to an outlet of the radiator 24.

According to an embodiment of the present disclosure, the control valve unit 30 may be configured to allow the reservoir tank 27 to be fluidly connected to the PE component 23 and/or the battery 22. When the reservoir tank 27 is fluidly connected to the PE component 23 and/or the battery 22 by the control valve unit 30, the coolant discharged from the reservoir tank 27 may pass through the PE component 23 and/or the battery 22.

The coolant system 20 may further include a warmer 25 fluidly connected to the control valve unit 30. The warmer 25 may include a coolant passage provided therein, and the coolant may pass through the coolant passage of the warmer 25. The warmer 25 may be fluidly connected to the coolant passage 12b of the water-cooled condenser 12. According to an embodiment, the warmer 25 may be an electric heater configured to heat the coolant using electric energy. When the heating of the cabin or the warming-up of the battery 22 is required, the warmer 25 may be turned on. As the warmer 25 is turned on, the coolant may be heated by the warmer 25. When the warmer 25 is turned off, the coolant may pass through the coolant passage of the warmer 25 without being heated by the warmer 25.

According to an embodiment of the present disclosure, the control valve unit 30 may be configured to allow the warmer 25 and the cabin heater 21 to be fluidly connected or disconnected.

The coolant system 20 may further include an auxiliary pump 44 fluidly connected to the control valve unit 30.

According to an embodiment of the present disclosure, the control valve unit 30 may be configured to allow the auxiliary pump 44 and the coolant passage 15b of the chiller 15 to be fluidly connected or disconnected.

The control valve unit 30 may include a first cabin port 31 and a second cabin port 32 fluidly communicating with the cabin heater 21. As the first cabin port 31 and the second cabin port 32 fluidly communicate with the coolant passage of the cabin heater 21, the coolant may pass through the coolant passage of the cabin heater 21 through the first cabin port 31 and the second cabin port 32 of the control valve unit 30.

The control valve unit 30 may include a first condenser port 36 and a second condenser port 37 fluidly communicating with the coolant passage 12b of the water-cooled condenser 12. As the first condenser port 36 and the second condenser port 37 fluidly communicate with the coolant passage 12b of the water-cooled condenser 12, the coolant may pass through the coolant passage 12b of the water-cooled condenser 12 through the first condenser port 36 and the second condenser port 37 of the control valve unit 30.

The control valve unit 30 may include a battery port 33 fluidly communicating with the battery 22. As the battery port 33 fluidly communicates with the coolant passage of the battery 22, the coolant may pass through the coolant passage of the battery 22 through the battery port 33 of the control valve unit 30.

The control valve unit 30 may include a component port 34 fluidly communicating with the PE component 23. As the component port 34 fluidly communicates with the coolant passage of the PE component 23, the coolant may pass through the coolant passage of the PE component 23 through the component port 34 of the control valve unit 30.

The control valve unit 30 may include a radiator port 35 fluidly communicating with the radiator 24. As the radiator port 35 fluidly communicates with the coolant passage of the radiator 24, the coolant may pass through the coolant passage of the radiator 24 through the radiator port 35 of the control valve unit 30.

The control valve unit 30 may include a first chiller port 38 and a second chiller port 39 fluidly communicating with the coolant passage 15b of the chiller 15. As the first chiller port 38 and the second chiller port 39 fluidly communicate with the coolant passage 15b of the chiller 15, the coolant may pass through the coolant passage 15b of the chiller 15 through the first chiller port 38 and the second chiller port 39 of the control valve unit 30.

According to an embodiment of the present disclosure, the control valve unit 30 may be configured to allow the first cabin port 31 and the first condenser port 36 to be fluidly connected or disconnected, and allow the second cabin port 32 and the second condenser port 37 to be fluidly connected or disconnected. When the control valve unit 30 fluidly connects the first cabin port 31 and the first condenser port 36, and fluidly connects the second cabin port 32 and the second condenser port 37, the coolant may pass through the coolant passage 12b of the water-cooled condenser 12 and the coolant passage of the cabin heater 21. When the control valve unit 30 fluidly disconnects the first cabin port 31 from the first condenser port 36, and fluidly disconnects the second cabin port 32 from the second condenser port 37, the coolant may not pass through the coolant passage 12b of the water-cooled condenser 12 and the coolant passage of the cabin heater 21.

According to an embodiment of the present disclosure, the control valve unit 30 may be configured to allow the battery port 33 to be fluidly connected to at least one of the first chiller port 38, the radiator port 35, or the first condenser port 36. In other words, the battery port 33 is fluidly connected to the first chiller port 38, the radiator port 35, or the first condenser port 36, or any combination thereof. When the control valve unit 30 fluidly connects the battery port 33 and the first chiller port 38, the coolant may pass through the coolant passage of the battery 22 and the coolant passage 15b of the chiller 15. When the control valve unit 30 fluidly connects the battery port 33 and the radiator port 35, the coolant may pass through the coolant passage of the radiator 24, the reservoir tank 27, and the coolant passage of the battery 22. When the control valve unit 30 fluidly connects the battery port 33 and the first condenser port 36, the coolant may pass through the coolant passage 12b of the water-cooled condenser 12, the coolant passage of the warmer 25, and the coolant passage of the battery 22.

According to an embodiment of the present disclosure, the control valve unit 30 may be configured to allow the component port 34 to be fluidly connected to at least one of the radiator port 35 or the first chiller port 38. When the control valve unit 30 fluidly connects the component port 34 and the radiator port 35, the coolant may pass through the coolant passage of the radiator 24 and the coolant passage of the PE component 23. When the control valve unit 30 fluidly connects the component port 34 and the first chiller port 38, the coolant may pass through the coolant passage of the PE component 23 and the coolant passage 15b of the chiller 15.

According to an embodiment of the present disclosure, the control valve unit 30 may be configured to allow the radiator port 35 to be fluidly connected to at least one of the component port 34, the first condenser port 36, or the battery port 33. When the control valve unit 30 fluidly connects the radiator port 35 and the component port 34, the coolant may pass through the coolant passage of the radiator 24 and the coolant passage of the PE component 23. When the control valve unit 30 fluidly connects the radiator port 35 and the first condenser port 36, the coolant may pass through the coolant passage of the radiator 24 and the coolant passage 12b of the water-cooled condenser 12. When the control valve unit 30 fluidly connects the radiator port 35 and the battery port 33, the coolant may pass through the coolant passage of the radiator 24 and the coolant passage of the battery 22.

The coolant system 20 may include a cabin pump 41 fluidly connected to the first cabin port 31 of the control valve unit 30, a battery pump 42 fluidly connected to the battery port 33 of the control valve unit 30, and a radiator pump 43 fluidly connected to the radiator port 35 of the control valve unit 30. As the cabin pump 41, the battery pump 42, and the radiator pump 43 selectively operate, the coolant may flow in various directions. As the cabin pump 41 operates, the coolant may pass through the coolant passage of the cabin heater 21. As the battery pump 42 operates, the coolant may pass through the coolant passage of the battery 22. As the radiator pump 43 operates, the coolant may pass through the coolant passage of the radiator 24.

The control valve unit 30 may further include an auxiliary port 40 fluidly communicating with the auxiliary pump 44.

According to an embodiment of the present disclosure, the control valve unit 30 may be configured to allow the auxiliary port 40 and the second chiller port 39 to be fluidly connected to or disconnected from each other. When the control valve unit 30 fluidly connects the auxiliary port 40 and the second chiller port 39, the coolant may pass through the auxiliary pump 44 and the coolant passage 15b of the chiller 15.

The coolant system 20 may include a coolant circulation path 80 allowing the coolant to circulate. The coolant circulation path 80 may include a first coolant line 81 connected to the first cabin port 31 of the control valve unit 30, and a second coolant line 82 connected to the second cabin port 32 of the control valve unit 30. The coolant circulation path 80 may also include a third coolant line 83 connected to the battery port 33 of the control valve unit 30, a fourth coolant line 84 connected to the component port 34 of the control valve unit 30, a fifth coolant line 85 connected to the radiator port 35 of the control valve unit 30, and a sixth coolant line 86 connected to the first condenser port 36 of the control valve unit 30. Additionally, the coolant circulation path 80 may include a seventh coolant line 87 connected to the second condenser port 37 of the control valve unit 30, an eighth coolant line 88 connected to the first chiller port 38 of the control valve unit 30, a ninth coolant line 89 connected to the second chiller port 39 of the control valve unit 30, and a tenth coolant line 90 connected to the auxiliary port 40 of the control valve unit 30.

The first coolant line 81 may connect the first cabin port 31 of the control valve unit 30 and a first port of the cabin heater 21. The cabin pump 41 may be fluidly connected to the first coolant line 81.

The second coolant line 82 may connect the second cabin port 32 of the control valve unit 30 and a second port of the cabin heater 21.

The third coolant line 83 may be connected to the ninth coolant line 89 through a first connection line 45. The first connection line 45 may connect the third coolant line 83 and the ninth coolant line 89. In addition, the third coolant line 83 may be connected to the second coolant line 82 through a second connection line 46. The second connection line 46 may connect the third coolant line 83 and the second coolant line 82. The battery pump 42 and the coolant passage of the battery 22 may be fluidly connected to the third coolant line 83.

The fourth coolant line 84 may be connected to the tenth coolant line 90. The coolant passage of the PE component 23 may be fluidly connected to the fourth coolant line 84.

The fifth coolant line 85 may be connected to the seventh coolant line 87 and the tenth coolant line 90. The coolant passage of the radiator 24, the reservoir tank 27, and the radiator pump 43 may be fluidly connected to the fifth coolant line 85.

The sixth coolant line 86 may connect the first condenser port 36 of the control valve unit 30 and the seventh coolant line 87. The warmer 25 and the coolant passage 12b of the water-cooled condenser 12 may be fluidly connected to the sixth coolant line 86.

The seventh coolant line 87 may be connected to the fifth coolant line 85 and the tenth coolant line 90.

The eighth coolant line 88 may connect the first chiller port 38 of the control valve unit 30 and a first port of the coolant passage 15b of the chiller 15.

The ninth coolant line 89 may connect the second chiller port 39 of the control valve unit 30 and a second port of the coolant passage 15b of the chiller 15.

The tenth coolant line 90 may be connected to the fourth coolant line 84, the fifth coolant line 85, and the seventh coolant line 87. The auxiliary pump 44 may be fluidly connected to the tenth coolant line 90.

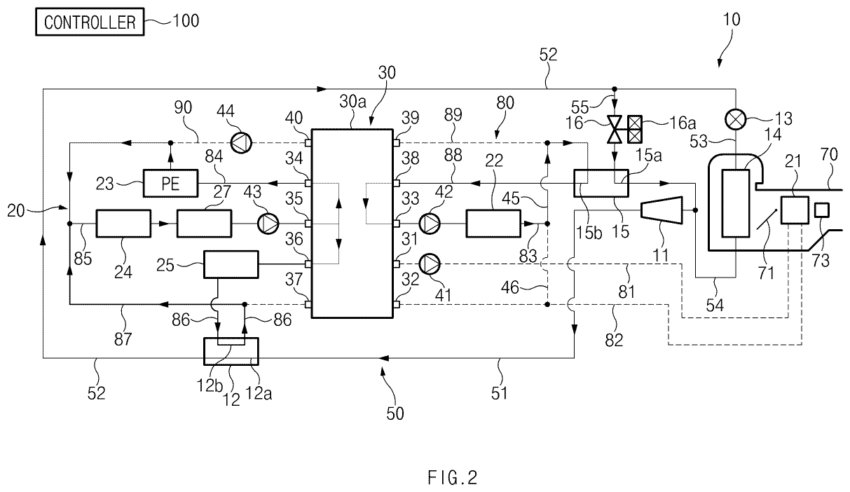

FIG. 2 illustrates a state in which the vehicle thermal management system according to an embodiment of the present disclosure operates in a first mode. Referring to FIG. 2, when the vehicle thermal management system operates in the first mode, the battery 22 may be cooled by the chiller 15, the PE component 23 may be cooled by the radiator 24, and the heating of the cabin may not be performed.

Referring to FIG. 2, the control valve unit 30 may fluidly disconnect the first cabin port 31 from the first condenser port 36, and fluidly disconnect the second cabin port 32 from the second condenser port 37 so that the coolant may not circulate between the coolant passage 12b of the water-cooled condenser 12 and the cabin heater 21. Since the coolant heated by the water-cooled condenser 12 is not transferred to the cabin heater 21, the heating of the cabin may not be performed.

Referring to FIG. 2, the control valve unit 30 may fluidly connect the battery port 33 and the first chiller port 38 so that the coolant may pass through the coolant passage of the battery 22 and the coolant passage 15b of the chiller 15 by the battery pump 42. As the opening degree of the chiller-side expansion valve 16 of the refrigerant system 10 is adjusted, the refrigerant may be expanded by the chiller-side expansion valve 16, and the expanded refrigerant may pass through the refrigerant passage 15a of the chiller 15. The coolant absorbing the waste heat of the battery 22 may pass through the coolant passage 15b of the chiller 15. The coolant passing through the coolant passage 15b of the chiller 15 may transfer heat to the refrigerant passing through the refrigerant passage 15a of the chiller 15 so that the coolant may be cooled, and the refrigerant may be heated or evaporated.

Referring to FIG. 2, the control valve unit 30 may connect the radiator port 35 and the component port 34 so that the coolant may pass through the coolant passage of the radiator 24 and the coolant passage of the PE component 23 by the radiator pump 43. In addition, the control valve unit 30 may connect the radiator port 35 and the first condenser port 36 so that the coolant may pass through the coolant passage of the radiator 24, the coolant passage of the warmer 25, and the coolant passage 12b of the water-cooled condenser 12 by the radiator pump 43. Accordingly, the coolant cooled by the radiator 24 may be distributed to the coolant passage of the PE component 23 and the coolant passage 12b of the water-cooled condenser 12 at a predetermined ratio so that the PE component 23 may be cooled, and the refrigerant passing through the refrigerant passage 12a of the water-cooled condenser 12 may be condensed.

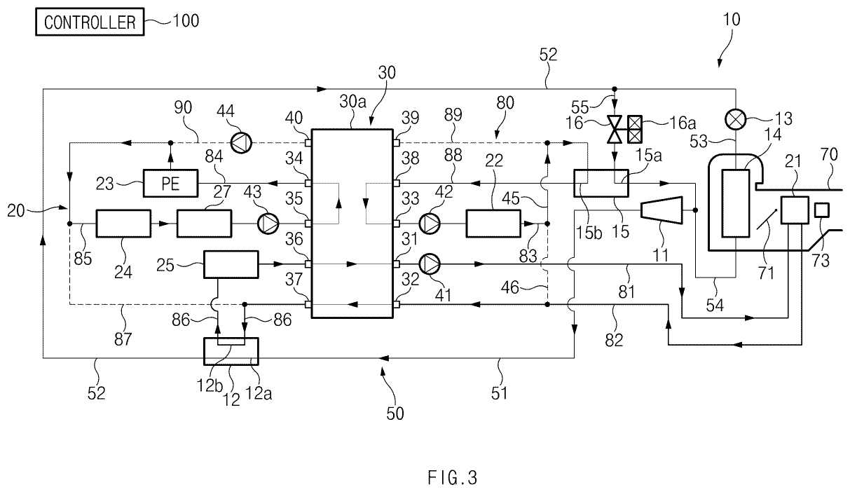

FIG. 3 illustrates a state in which the vehicle thermal management system according to an embodiment of the present disclosure operates in a second mode. Referring to FIG. 3, when the vehicle thermal management system operates in the second mode, the battery 22 may be cooled by the chiller 15, the PE component 23 may be cooled by the radiator 24, and the heating of the cabin may be performed.

Referring to FIG. 3, the control valve unit 30 may fluidly connect the first cabin port 31 and the first condenser port 36, and fluidly connect the second cabin port 32 and the second condenser port 37 so that the coolant may circulate between the coolant passage 12b of the water-cooled condenser 12 and the cabin heater 21 by the cabin pump 41. The coolant heated by the water-cooled condenser 12 may be transferred to the cabin heater 21 so that the cabin heater 21 may heat the air flowing into the cabin, and thus the heating of the cabin may be performed.

Referring to FIG. 3, the control valve unit 30 may fluidly connect the battery port 33 and the first chiller port 38 so that the coolant may pass through the coolant passage of the battery 22 and the coolant passage 15b of the chiller 15 by the battery pump 42. As the opening degree of the chiller-side expansion valve 16 of the refrigerant system 10 is adjusted, the refrigerant may be expanded by the chiller-side expansion valve 16, and the expanded refrigerant may pass through the refrigerant passage 15a of the chiller 15. The coolant absorbing the waste heat of the battery 22 may pass through the coolant passage 15b of the chiller 15. The coolant passing through the coolant passage 15b of the chiller 15 may transfer heat to the refrigerant passing through the refrigerant passage 15a of the chiller 15 so that the coolant may be cooled, and the refrigerant may be heated or evaporated. Since the refrigerant circulating in the refrigerant system 10 can be sufficiently evaporated by the chiller 15, the refrigerant may be sufficiently condensed by the water-cooled condenser 12. Accordingly, the coolant heated by the water-cooled condenser 12 may be directed to the cabin heater 21 so that the cabin heater 21 may sufficiently heat the air flowing into the cabin. As the warmer 5 is selectively turned on, the coolant may be additionally heated by the warmer 25.

Referring to FIG. 3, the control valve unit 30 may connect the radiator port 35 and the component port 34 so that the coolant may pass through the coolant passage of the radiator 24 and the coolant passage of the PE component 23 by the radiator pump 43. Accordingly, the coolant cooled by the radiator 24 may be directed to the coolant passage of the PE component 23 so that the PE component 23 may be properly cooled.

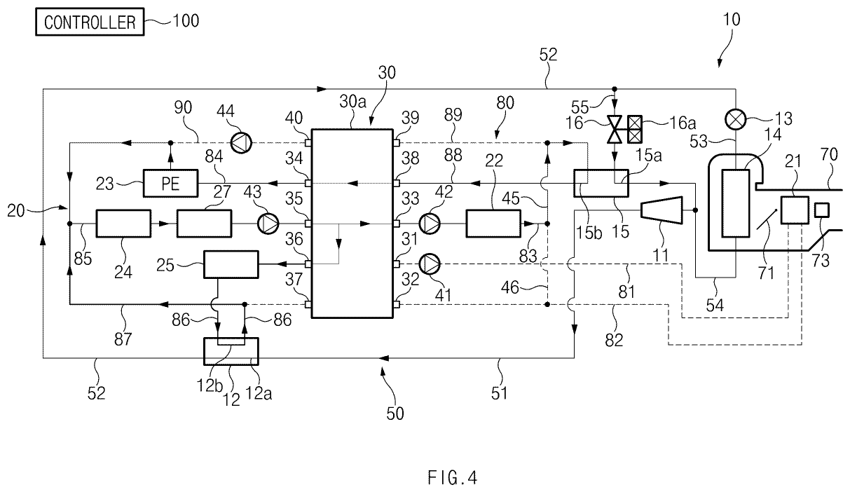

FIG. 4 illustrates a state in which the vehicle thermal management system according to an embodiment of the present disclosure operates in a third mode. Referring to FIG. 4, when the vehicle thermal management system operates in the third mode, the battery 22 and the PE component 23 may be cooled by the chiller 15 and the radiator 24, and the heating of the cabin may not be performed.

Referring to FIG. 4, the control valve unit 30 may fluidly disconnect the first cabin port 31 from the first condenser port 36, and fluidly disconnect the second cabin port 32 from the second condenser port 37 so that the coolant may not circulate between the coolant passage 12b of the water-cooled condenser 12 and the cabin heater 21. Since the coolant heated by the water-cooled condenser 12 is not transferred to the cabin heater 21, the heating of the cabin may not be performed.

Referring to FIG. 4, the control valve unit 30 may fluidly connect the component port 34 and the first chiller port 38. Additionally, the control valve unit 30 may fluidly connect the radiator port 35, the battery port 33, and the first condenser port 36 so that the coolant may pass through the coolant passage of the radiator 24, the coolant passage of the battery 22, the coolant passage 15b of the chiller 15, the coolant passage of the PE component 23, and the coolant passage 12b of the water-cooled condenser 12 by the battery pump 42 and the radiator pump 43. A portion of the coolant cooled by the radiator 24 may pass through the coolant passage of the battery 22, the coolant passage 15b of the chiller 15, and the coolant passage of the PE component 23 so that the coolant may be cooled by the chiller 15 and the radiator 24, and the battery 22 and the PE component 23 may be cooled. A remaining portion of the coolant cooled by the radiator 24 may pass through the coolant passage 12b of the water-cooled condenser 12 so that the refrigerant passing through the refrigerant passage 12a of the water-cooled condenser 12 may be properly condensed.

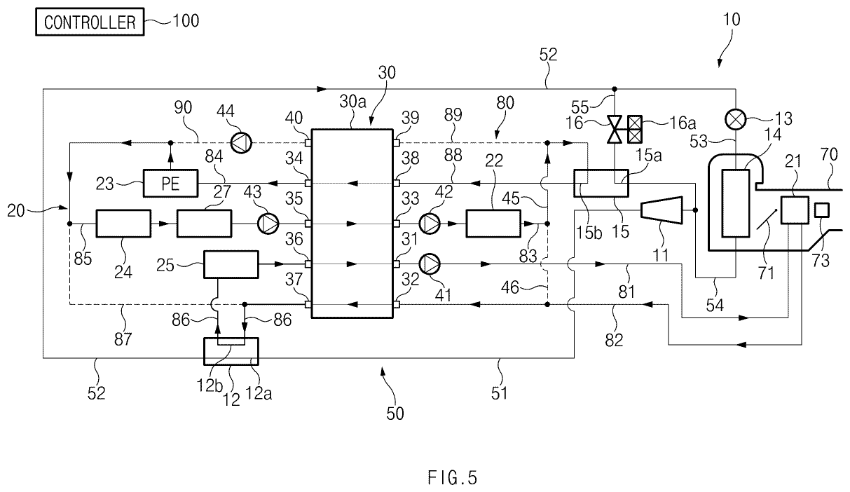

FIG. 5 illustrates a state in which the vehicle thermal management system according to an embodiment of the present disclosure operates in a fourth mode. Referring to FIG. 5, when the vehicle thermal management system operates in the fourth mode, the battery 22 and the PE component 23 may be cooled by the chiller 15 and the radiator 24, and the heating of the cabin may be performed.

Referring to FIG. 5, the control valve unit 30 may fluidly connect the first cabin port 31 and the first condenser port 36, and fluidly connect the second cabin port 32 and the second condenser port 37 so that the coolant may circulate between the coolant passage 12b of the water-cooled condenser 12 and the cabin heater 21 by the cabin pump 41. The coolant heated by the water-cooled condenser 12 may be transferred to the cabin heater 21 so that the cabin heater 21 may heat the air flowing into the cabin, and thus the heating of the cabin may be performed.

Referring to FIG. 5, the control valve unit 30 may fluidly connect the component port 34 and the first chiller port 38, and fluidly connect the radiator port 35 and the battery port 33 so that the coolant may pass through the coolant passage of the radiator 24, the coolant passage of the battery 22, the coolant passage 15b of the chiller 15, and the coolant passage of the PE component 23 by the battery pump 42 and the radiator pump 43. The coolant cooled by the radiator 24 may pass through the coolant passage of the battery 22, the coolant passage 15b of the chiller 15, and the coolant passage of the PE component 23 so that the coolant may be cooled by the chiller 15 and the radiator 24, and the battery 22 and the PE component 23 may be cooled. As the opening degree of the chiller-side expansion valve 16 of the refrigerant system 10 is adjusted, the refrigerant may be expanded by the chiller-side expansion valve 16. The expanded refrigerant may pass through the refrigerant passage 15a of the chiller 15. The coolant absorbing the waste heat of the battery 22 and the waste heat of the PE component 23 may pass through the coolant passage 15b of the chiller 15. The coolant passing through the coolant passage 15b of the chiller 15 may transfer heat to the refrigerant passing through the refrigerant passage 15a of the chiller 15 so that the coolant may be cooled, and the refrigerant may be heated or evaporated. Since the refrigerant circulating in the refrigerant system 10 can be sufficiently evaporated by the chiller 15, the refrigerant may be sufficiently condensed by the water-cooled condenser 12. Accordingly, the coolant heated by the water-cooled condenser 12 may be directed to the cabin heater 21 so that the cabin heater 21 may sufficiently heat the air flowing into the cabin. As the warmer 25 is selectively turned on, the coolant may be additionally heated by the warmer 25.

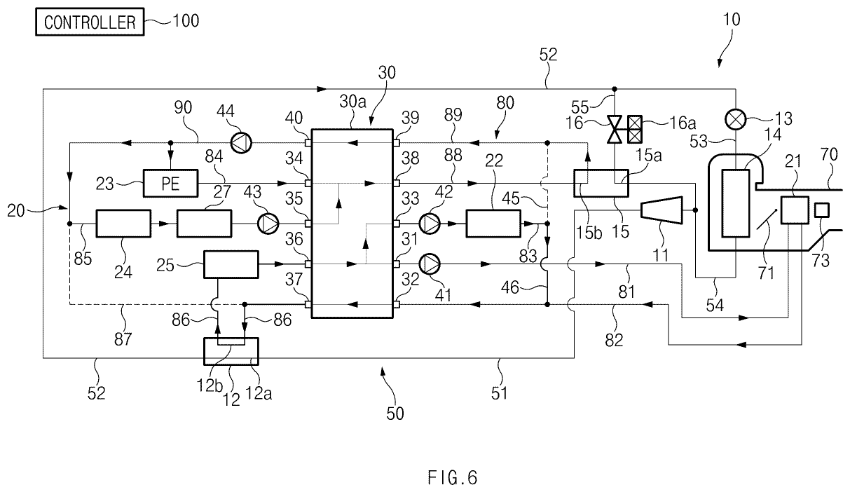

FIG. 6 illustrates a state in which the vehicle thermal management system according to an embodiment of the present disclosure operates in a fifth mode. Referring to FIG. 6, when the vehicle thermal management system operates in the fifth mode, the heat of the ambient air and the waste heat of the PE component 23 may be recovered in the chiller 15, and the heating of the cabin and/or the warming-up of the battery 22 may be performed.

Referring to FIG. 6, the control valve unit 30 may fluidly connect the first cabin port 31 and the first condenser port 36, and fluidly connect the second cabin port 32 and the second condenser port 37 so that the coolant may circulate between the coolant passage 12b of the water-cooled condenser 12 and the cabin heater 21. The coolant heated by the water-cooled condenser 12 may be transferred to the cabin heater 21 so that the cabin heater 21 may heat the air flowing into the cabin, and thus the heating of the cabin may be performed.

Referring to FIG. 6, the control valve unit 30 may fluidly connect the component port 34, the first chiller port 38, and the radiator port 35. The control valve unit 30 may also fluidly connect the auxiliary port 40 and the second chiller port 39 so that the coolant discharged from the coolant passage of the PE component 23 may pass through the coolant passage 15b of the chiller 15 by the auxiliary pump 44. The coolant discharged from the coolant passage of the radiator 24 may pass through the coolant passage 15b of the chiller 15 by the radiator pump 43. The coolant discharged from the coolant passage of the PE component 23 and the coolant discharged from the coolant passage of the radiator 24 may be joined in the internal passage of the control valve unit 30, and be directed to the coolant passage 15b of the chiller 15. As the opening degree of the chiller-side expansion valve 16 of the refrigerant system 10 is adjusted, the refrigerant may be expanded by the chiller-side expansion valve 16. The expanded refrigerant may pass through the refrigerant passage 15a of the chiller 15. The coolant absorbing the waste heat of the PE component 23 may pass through the coolant passage 15b of the chiller 15, and the coolant passing through the coolant passage 15b of the chiller 15 may transfer heat to the refrigerant passing through the refrigerant passage 15a of the chiller 15 so that the coolant may be cooled, and the refrigerant may be heated or evaporated.

Referring to FIG. 6, the control valve unit 30 may fluidly connect the battery port 33 and the first condenser port 36 so that the coolant discharged from the coolant passage 12b of the water-cooled condenser 12 may be distributed to the coolant passage of the cabin heater 21 and the coolant passage of the battery 22 at a predetermined ratio. A portion of the coolant discharged from the coolant passage 12b of the water-cooled condenser 12 may pass through the coolant passage of the battery 22 by the battery pump 42. Additionally, the coolant discharged from the coolant passage of the battery 22 may be joined to the second coolant line 82 and be directed to the coolant passage 12b of the water-cooled condenser 12. Accordingly, the coolant heated by the water-cooled condenser 12 may pass through the coolant passage of the battery 22 so that the battery 22 may be properly warmed up.

As described above, the coolant heated by the water-cooled condenser 12 may be directed to the coolant passage of the cabin heater 21 and/or the coolant passage of the battery 22 so that the heating of the cabin and/or the warming-up of the battery may be performed. As the warmer 25 is selectively turned on, the coolant may be additionally heated by the warmer 25.

Referring to FIGS. 1 to 7, the control valve unit 30 may include a single valve housing 30a having the plurality of ports 31, 32, 33, 34, 35, 36, 37, 38, 39, and 40.

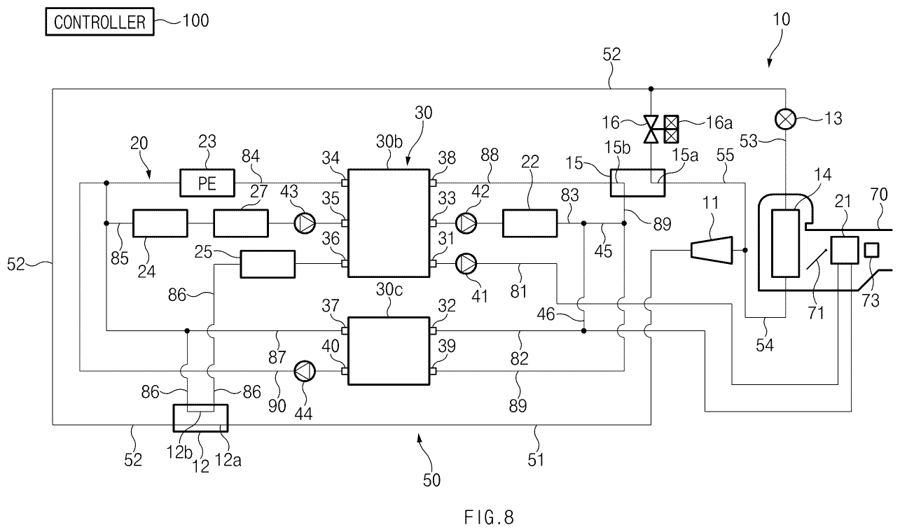

According to an alternative embodiment, the control valve unit 30 may include a plurality of physically separated valve housings. As the plurality of valve housings are physically separated, the layout of the thermal management system may be changed in various ways. Referring to FIG. 8, the control valve unit 30 of the vehicle thermal management system according to another embodiment of the present disclosure may include a first valve housing 30b and a second valve housing 30c that are physically separated. The first valve housing 30b may have the first cabin port 31, the battery port 33, the component port 34, the radiator port 35, the first condenser port 36, and the first chiller port 38. The second valve housing 30c may have the second cabin port 32, the second condenser port 37, the second chiller port 39, and the auxiliary port 40.

As set forth above, the vehicle thermal management system according to embodiments of the present disclosure may be designed to efficiently perform the heating and cooling of the cabin, thermal management of the battery, and thermal management of the PE component. As a result, the electric efficiency of the vehicle may be improved.

According to the embodiments of the present disclosure, by employing a system that heats air using the coolant, the number of components may be significantly reduced and the weight of the vehicle thermal management system may be reduced. In addition, the price of some components may be relatively low, thus reducing the manufacturing cost of the vehicle thermal management system.

According to the embodiments of the present disclosure, the coolant heated by the water-cooled condenser may heat the air flowing into the cabin through the cabin heater disposed in the HVAC case so that the heating of the cabin may be efficiently performed. As the vehicle thermal management system according to the related art has an interior condenser that condenses a refrigerant within an HVAC case, it may have the following disadvantages: the air heating performance of the interior condenser may be relatively reduced, and the price of the interior condenser may be relatively high. On the other hand, the vehicle thermal management system according to the embodiments of the present disclosure may achieve relatively high air heating performance using the cabin heater, and the cabin heater may be relatively inexpensive.

Hereinabove, although the present disclosure has been described with reference to the embodiments and the accompanying drawings, the present disclosure is not limited thereto. However, the present disclosure may be variously modified and altered by those having ordinary skill in the art to which the present disclosure pertains without departing from the spirit and scope of the present disclosure claimed in the following claims.

What is claimed is:

1. A vehicle thermal management system, comprising:
a refrigerant system including a compressor, a water-cooled condenser, a chiller-side expansion valve, and a chiller; and
a coolant system including a cabin heater, a battery, a power electronics (PE) component, and a control valve unit,
wherein the water-cooled condenser includes a refrigerant passage through which a refrigerant passes, and a coolant passage through which a coolant passes, and
wherein the control valve unit is configured to allow the coolant passage of the water-cooled condenser and the cabin heater to be fluidly connected to or disconnected from each other.

2. The vehicle thermal management system according to claim 1, wherein the control valve unit is configured to allow the coolant passage of the water-cooled condenser and the battery to be fluidly connected to or disconnected from each other.

3. The vehicle thermal management system according to claim 1, wherein the control valve unit includes a first cabin port and a second cabin port configured to fluidly communicate with the cabin heater.

4. The vehicle thermal management system according to claim 3, wherein the control valve unit includes a first condenser port and a second condenser port configured to fluidly communicate with the coolant passage of the water-cooled condenser.

5. The vehicle thermal management system according to claim 4, wherein the control valve unit is configured to allow the first cabin port and the first condenser port to be fluidly connected to or disconnected from each other, and
wherein the control valve unit is configured to allow the second cabin port and the second condenser port to be fluidly connected to or disconnected from each other.

6. The vehicle thermal management system according to claim 3, wherein the coolant system includes a cabin pump configured to fluidly connect to the first cabin port.

7. The vehicle thermal management system according to claim 4, wherein the control valve unit includes a battery port configured to fluidly communicate with the battery, and a component port configured to fluidly communicate with the PE component.

8. The vehicle thermal management system according to claim 7, wherein the coolant system includes a battery pump configured to fluidly connect to the battery port.

9. The vehicle thermal management system according to claim 7, wherein the coolant system further includes a radiator configured to fluidly connect to the control valve unit, and
wherein the control valve unit includes a radiator port configured to fluidly communicate with the radiator.

10. The vehicle thermal management system according to claim 9, wherein the coolant system includes a radiator pump configured to fluidly connect to the radiator port.

11. The vehicle thermal management system according to claim 9, wherein the control valve unit is configured to allow the coolant passage of the water-cooled condenser and the radiator to be fluidly connected to or disconnected from each other.

12. The vehicle thermal management system according to claim 9, wherein the control valve unit is configured to allow the radiator to be fluidly connected to at least one of the PE component or the battery.

13. The vehicle thermal management system according to claim 9, wherein the chiller includes a refrigerant passage through which the refrigerant passes, and a coolant passage through which the coolant passes.

14. The vehicle thermal management system according to claim 13, wherein the control valve unit includes a first chiller port and a second chiller port configured to fluidly communicate with the coolant passage of the chiller.

15. The vehicle thermal management system according to claim 14, wherein the control valve unit is configured to allow the battery port to be fluidly connected to at least one of the first chiller port, the radiator port, or the first condenser port.

16. The vehicle thermal management system according to claim 14, wherein the control valve unit is configured to allow the component port to be fluidly connected to at least one of the radiator port or the first chiller port.

17. The vehicle thermal management system according to claim 14, wherein the control valve unit is configured to allow the radiator port to be fluidly connected to at least one of the component port, the first condenser port, or the battery port.

18. The vehicle thermal management system according to claim 14, wherein the coolant system further includes an auxiliary pump configured to be fluidly connect to the control valve unit, and
wherein the control valve unit further includes an auxiliary port configured to fluidly communicate with the auxiliary pump.

19. The vehicle thermal management system according to claim 18, wherein the control valve unit is configured to allow the auxiliary port and the second chiller port to be fluidly connected to or disconnected from each other.
